(19) United States
(12) Patent Application Publication
(10) Pub. No.: US 2026/0244452 A1
(43) Pub. Date: Aug. 20, 2026

(54) CHIPLET INTEGRATED CIRCUIT (IC) INCLUDING MULTIPLE CHIPLETS AND SHARED EXTERNAL BUS

(71) Applicant: Arm Limited, Cambridge (GB)

(72) Inventors: Deepak Goel, San Jose, CA (US); Hemang Ganesh Lotlikar, San Diego, CA (US); Peter Andrew Rees Williams, Great Abington (GB)

(21) Appl. No.: 19/056,634

(22) Filed: Feb. 18, 2025

(51) Int. Cl. G06F 9/4401; G06F 15/78

(52) U.S. Cl. CPC G06F 9/4405; G06F 15/7807

(57) ABSTRACT

Briefly, example apparatuses, articles of manufacture, and/or techniques are disclosed that may be implemented, in whole or in part, to implement, facilitate and/or support code retrieval from a shared storage element by integrated circuits comprising co-packaged chiplets.

### FIELD

The present disclosure relates generally to containerization, and more particularly, container image support for multiple architectures.

### BACKGROUND

In a chiplet-based integrated circuit (IC) multiple individual IC dies (chiplets) may be packaged together to form a unified IC device, which may be known as a “multi-chip module,” “hybrid IC,” “2.5D IC,” “advanced package,” “system-level package,” “system-in-package,” and/or the like. Chiplet technology may provide aspects such as ability to mix-and-match different chiplets in different devices, support for heterogeneous integration (e.g., use of chiplet dies having different pitches, sizes, materials, processes, etc…).

### BRIEF DESCRIPTION OF THE FIGURES

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 illustrates an example apparatus including a chiplet package in accordance with an implementation;

FIG. 2 illustrates an example method of chiplet operation in accordance with an implementation;

FIG. 3 illustrates an example device comprising a plurality of chiplet packages in accordance with an implementation;

FIG. 4 illustrates another example method of chiplet operation in accordance with an implementation; and

FIG. 5 illustrates an example non-transitory computer-readable medium comprising computer-readable code for a design of an apparatus in accordance with an implementation.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others, one or more aspects, properties, etc. may be omitted, such as for ease of discussion, or the like. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular example, implementation and/or embodiment is included in at least one example, implementation and/or embodiment of claimed subject matter. Thus, appearances of such phrases, for example, in various places throughout this specification are not necessarily intended to refer to the same implementation and/or embodiment and/or to any one particular implementation and/or embodiment. Furthermore, it is to be understood that particular features, structures, characteristics, and/or the like described are capable of being combined in various ways in one or more implementations and/or embodiments and, therefore, are within intended claim scope. Unless explicitly indicated to the contrary, reference to “another example” and/or “a further example” does not indicate that the described example is an exclusive alternative to a preceding example. In general, such examples may be alternatives to and/or additions to previous examples.

As used herein, the term “chiplet” may refer to one of a plurality of integrated circuits disposed within a common package. Chiplets may implement any type of circuitry, such as processing cores, arithmetic processing units, graphics processing units, application specific ICs (ASICs) such as accelerator cores, analog processing circuitry, analog-to-digital / digital-to-analog converters, networking circuitry, memory circuitry, and/or the like. As a simple example, a chiplet-based processor might comprise a number of chiplets that each implement a plurality of processing cores, a chiplet to implement a memory controller, and a chiplet-to-chiplet interconnect to provide the processing chiplets access to the memory chiplet. A chiplet may comprise circuitry to execute operational code, such as boot code as described below. In some cases, separate chiplets may be disposed on separate semiconductor dies. Chiplets may be connected within their package via a chiplet-to-chiplet interconnect. In some cases, such a chiplet-to-chiplet interconnect may be contained entirely within the chiplet package (e.g., lacking package contacts). Packages may expose and/or otherwise provide contacts for power and/or package-external signaling. Chiplets may have unique identities and/or operational roles within their package. For example, chiplets may have separate identifiers used for chiplet-to-chiplet communications. In some cases, a package of chiplets may appear as a single device with respect to devices external to the package. In other cases, a chiplet package may appear as separate devices corresponding to groups of one or more chiplets.

In some implementations, chiplets may include processing logic to execute boot code, for example as an aspect of initialization during a power-on event. In some implementations, boot code may be used in a security process during boot. For example, a chiplet may boot based on the validity of a digital signature. In some implementations, boot code may be used to implement alternative configurations. For example, a chiplet may be designed to have different functionality based on how it is packaged with other chiplets (e.g., identities) and boot code may assist a chiplet to implement a certain functionality. For example, a chiplet might comprise alternative external interconnects (e.g., a DDR5 interconnect and a CXL interconnect) and alternative identities where one of the external interconnects is active when the chiplet is implemented in a first package and the other of the external interconnects is active when the chiplet is implemented in a second package. In this example, chiplet identity (e.g., which interconnect is active) may be based, at least in part, on its boot code. As another example, a chiplet may configure various system parameters based on boot code, such as power levels, processing speeds, interconnect parameters (e.g., speed, bandwidth, coding scheme, etc..) and/or other configurable parameter options.

In some implementations, chiplet boot code may be stored externally to a chiplet package, such as, for example, on a physical storage element, networked storage location, etc.. (termed “boot code storage” herein). For example, a system may comprise a flash memory device coupled to a chiplet package. Accordingly, a chiplet package may include contacts (e.g., pins, pads, bumps, etc…) to provide a channel to retrieve boot code for its chiplets, such as via a bus. In some implementations, a boot code channel may be implemented separately from other package interconnects (e.g., if the other interconnects are activated as an aspect of the boot-up). Accordingly, a package may include contacts reserved for boot code loading. For example, a package may comprise an silicon interposer upon which its chiplets are disposed and through-silicon vias (TSVs) may connect contacts on the chiplet to corresponding package contacts. However, increasing package input/output (I/O) contacts to provide contacts for each chiplet may increase costs and impact IC design. Additionally, in some cases, a particular chiplet of a package may retrieve boot code for multiple chiplets, which it stores and provides to other chiplets in the package. However, the memory elements used in this approach may have an associated area penalty.

Aspects of the disclosed technology may address challenges such as these by providing a chiplet package where multiple chiplets may retrieve boot code from a boot code storage via a common interconnect. For example, in some implementations, a device may include a storage element coupled to an external bus of a chiplet package. The device may further include a first chiplet and a second chiplet. The first chiplet may be coupled to the external bus to retrieve first code from the storage element and may be coupled to an internal bus to communicate a control signal. The second chiplet may be coupled to the internal bus to receive the control signal from the first chiplet and may be coupled the external bus to retrieve second code from the storage element responsive to the control signal.

Further aspects of the disclosed technology may address challenges such as these by providing a method of a primary and second chiplet retrieving code from a common external bus terminal. For example, in some implementations, a method may include a first primary chiplet retrieving code from a storage element via an external bus terminal connected to an external bus. The first primary chiplet may communicate a control signal to a co-packaged secondary chiplet via an internal bus. The secondary chiplet may the control signal from the first primary chiplet, and, in response retrieve code from the storage element via the external bus terminal.

Still further aspects of the disclosed technology may provide a computer-readable medium storing computer-readable code for the fabrication of a device as described above and/or a device to function as described above.

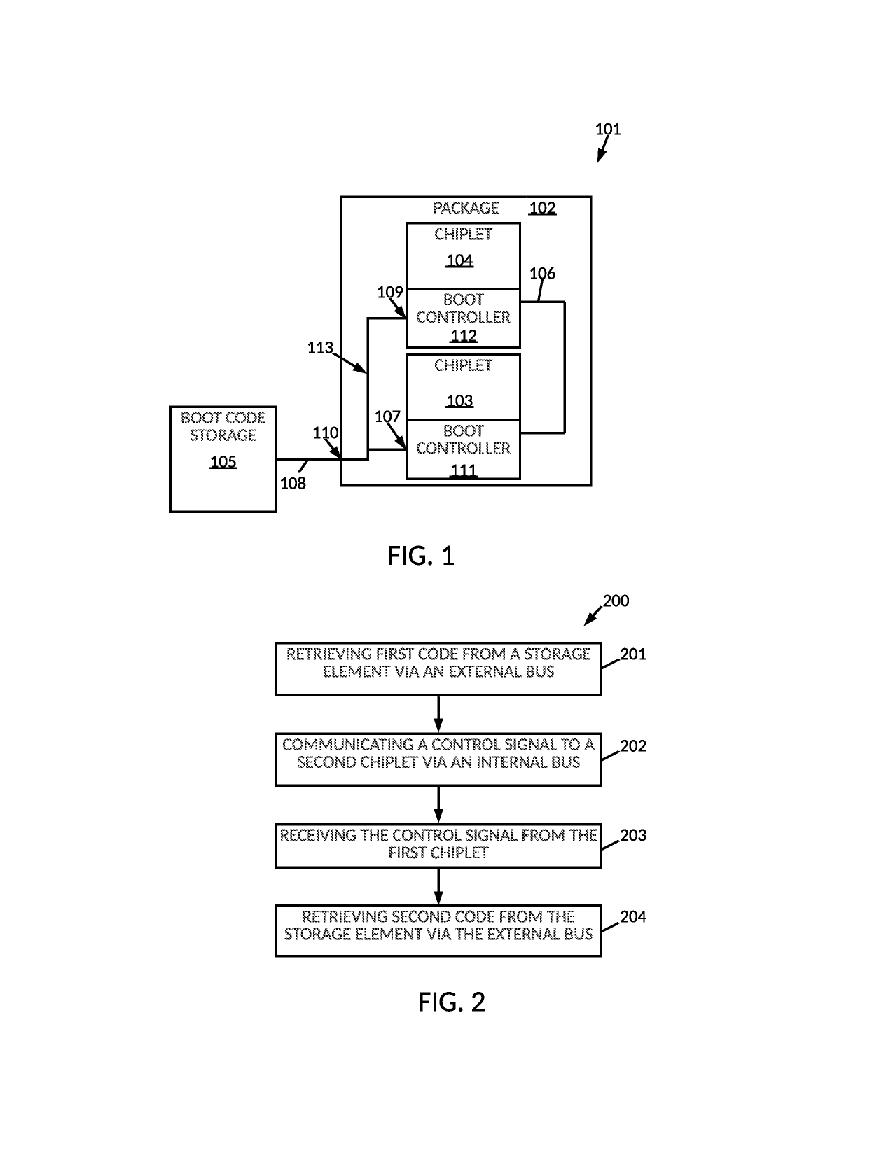

FIG. 1 illustrates a system 101 including a plurality of co-packaged chiplets 103, 104 and a boot code storage 105. For example, system 101 may comprise circuity disposed on a physical medium such as a printed circuit board (PCB).

In some implementations, system 101 may include a chiplet package 102. Chiplet package 102 may comprise chiplets such as a first chiplet 103 and a second chiplet 104. In various implementations, chiplet package 102 may comprise any package comprising chiplets (“advanced package”), such as, for example, a multi-chip module, a stacked IC package (“3D IC”), chiplets coupled to a interposer (“2.5D IC”), wafer-level fan-out package, quilted chiplet package, and/or other packaged IC. In various implementations, chiplets 103, 104 may have different designs, operational modes, functionality, etc… and/or may have similar/equivalent designs, operational modes, functionality, etc… Accordingly, package 102 may comprise any multi-chip device, such as, for example, an accelerator, micro controller, central processing unit (CPU), graphics processing unit (GPU), memory module, storage device, and/or other computing system component.

In some implementations, system 101 may include a boot code storage element 105 coupled to package 102 via a bus 108 (e.g., a package-external or “external bus” 108). For example, storage element 105 may comprise a persistent storage device, such as, for example, a field-programmable gate array (FPGA), a flash memory or other solid-state storage device, and/or the like. In some implementations, external bus 108 may comprise a relatively low-speed and/or relatively low-overhead bus (e.g., compared to a high-speed interconnect such as a compute express link, ethernet, DDRx interconnect, etc…). For example, external bus 108 may comprise a bus using a main-sub architecture, such as, for example, a Serial Peripheral Interface (SPI) bus, an I2C bus, an I3C bus, a JTAG bus, a Synchronous Serial Interface (SSI) bus, general purpose input/output (GPIO) (configured as a main-sub bus) and/or the like. In some implementations, storage element 105 may be coupled to external bus 108 as a sub (peripheral) device. As an example, storage element 105 may be coupled to package 102 via traces disposed on a circuit board (e.g., “wires”), such as, for example, a 2-, 3-, 4-wire bus, and/or the like. In some implementations, external bus 108 may be coupled to package 102 via contacts 110. For example, contacts 110 may comprise pins, pads, solder bumps, and/or the like.

In some implementations, chiplets 103, 104 may be coupled to external bus 108. For example, chiplets 103, 104 may be coupled to contacts 110 via a package-internal portion 113 of external bus 108. Chiplets 103, 104 may comprise logic to operate as main devices to orchestrate external bus 108. In some implementations, chiplets 103, 104 may be coupled to portion 113 via tri-state terminals 107, 109, respectively. In these implementations, chiplet 103, 104 may place tri-state terminal 107, 109 in a high-impedance state to disconnect from external bus 108 and may place tri-state terminal 107, 109 in a low-impedance state to connect to external bus 108. For example, external bus 108 may have a protocol providing a single main device and a chiplet 103, 104 may place terminal 107, 109 in a low-impedance to orchestrate external bus 108 as a main device.

In some implementations, chiplets 103, 104 may comprise a boot controller 111, 112. For example, boot controllers 111, 112 may comprise hardware implemented logic (e.g., a boot application specific integrated circuit (ASIC)), software/firmware implemented logic (e.g., a controller and storage such as a ROM, EEPROM, flash, etc… which stores boot program code executable by the controller), and/or combinations thereof. In some implementations, boot controller 111, 112 may comprise logic to perform operations to transition chiplet 103, 104 from an inactive state to an operational state, such as, for example as discussed with respect to FIGS. 2-4. As an example of boot operations, boot controller 111, 112 may configure its chiplet 103, 104 circuitry, such as, for example, controlling power-gating circuitry for various chiplet circuits (e.g., an inactive communication interconnect, processing component, etc…). As another example, boot controller 111, 112 may initialize its chiplet 103, 104 operation code, such as, for example, populating volatile memory with chiplet program code. As a further example, boot controller 111, 112 may perform various security and/or validation operations, such as comparing a retrieved digital signature to a stored digital signature and/or other root-of-trust validation. In this example, boot controller 111, 112 may continue booting if the security operation passes (e.g., the retrieved digital signature matches the stored digital signature) and may cease booting if the security operation fails.

In some implementations, device 101 may comprise a package-internal bus 106 (“internal bus 106”). As examples, internal bus 106 may be included on a package-internal interposer, a direct chiplet-to-chiplet interconnect, a package-internal wireless chiplet network, combinations thereof, and/or the like. In various implementations, internal bus 106 may have various bus architectures, such as a bus implementing a chiplet-to-chiplet protocol such as Bunch of Wires (BoW), a general protocol such as I2C, I3C, SPI, SSI, and/or the like, and/or a protocol-less digital signal interconnect, such as a general-purpose input/output (GPIO) bus.

In some implementations, during a boot operation, boot controllers 111, 112 may operate as main devices on bus 108 in a sequence. For example, a first boot controller 111 may be an initial main device on bus 108. In some implementations, both boot controllers 111, 112 may be capable of operating as an initial main device. In these implementations, the selection of which boot controller 111, 112 operates as an initial main device may be based on various conditions, such as, for example, an identifier of the chiplet 103, 104, a location of the chiplet (e.g., in a chiplet network topology or the like), random selection, and/or other like manners. In some implementations, as discussed below, the initial boot controller 111, 112 (the “primary boot controller” may orchestrate the booting of the other boot controllers (the “secondary boot controller(s)”). For ease of explanation, this description may include examples that may refer to boot controller 111 as primary boot controller 111 and chiplet 103 as primary chiplet 103, while boot controller 112 may be referred to as secondary boot controller 112 and chiplet 104 as secondary chiplet 104. Of course, in implementations, these roles may be reversed.

In some implementations, internal bus 106 may comprise a GPIO bus 106 comprising sufficient wires to provide a binary identifier/token for chiplets 103, 104 within package 102. For instance, in a two-chiplet implementation, internal bus 106 may comprise one wire to identify a first chiplet (e.g., with a low voltage on the wire) and a second chiplet (e.g., with a high voltage on the wire). As another example, in a four-chiplet implementation, internal bus 106 may comprise two wires to implement binary representations of four devices (e.g., high-high, high-low, low-high, low-low). Of course, in various implementations, some voltage states may be unused. For instance, in a 6-chiplet implementation having three internal wires, two of the 2^3=8 voltage states may be unused as chiplet identifiers. In some implementations, internal bus 106 may comprise a wire used by a secondary chiplet to indicate its boot status. For instance, a status wire may be held in a high voltage state when the secondary chiplet is in a ready state and may be de-asserted (e.g., driven to a low voltage) when the secondary chiplet is not in a ready state (e.g., retrieving boot code and/or booting). In some implementations, internal bus 106 may comprise a separate status wire for each chiplet or one or more shared status wires shared by all or groups of chiplets.

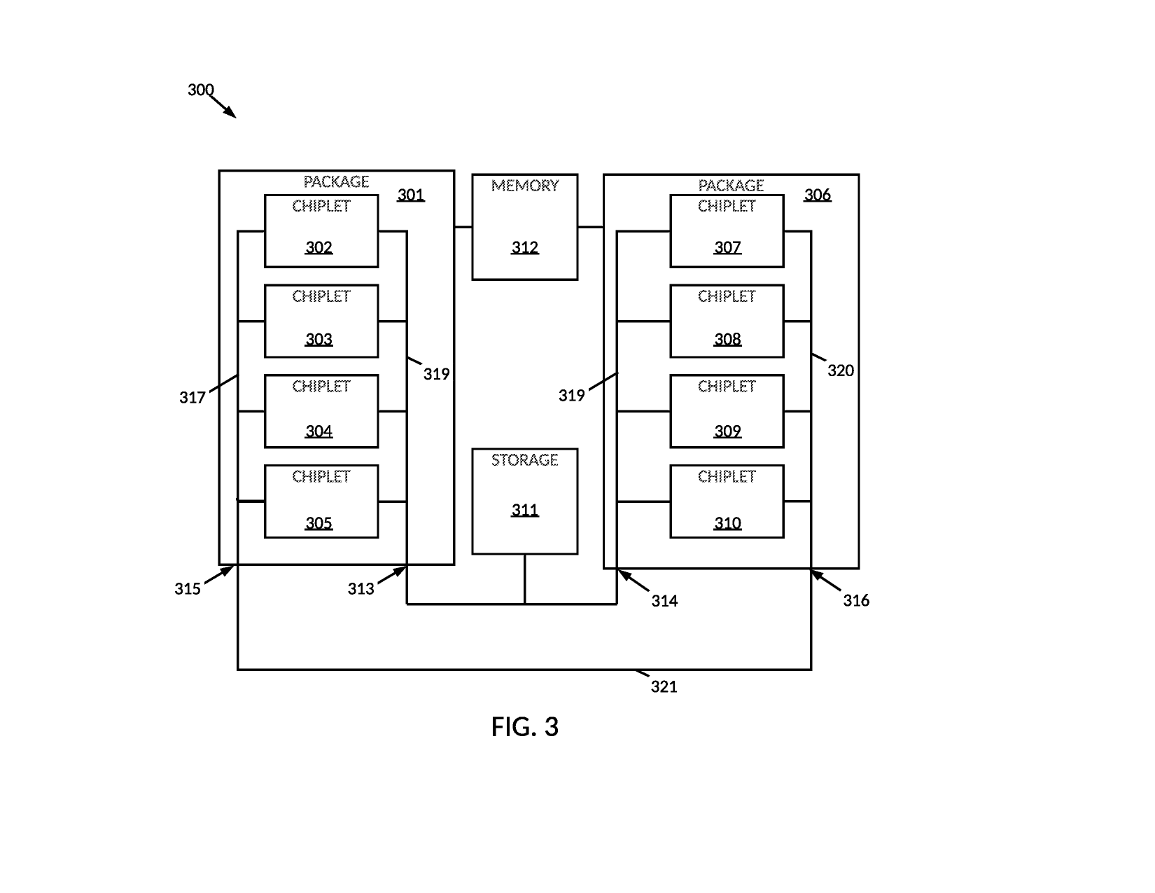

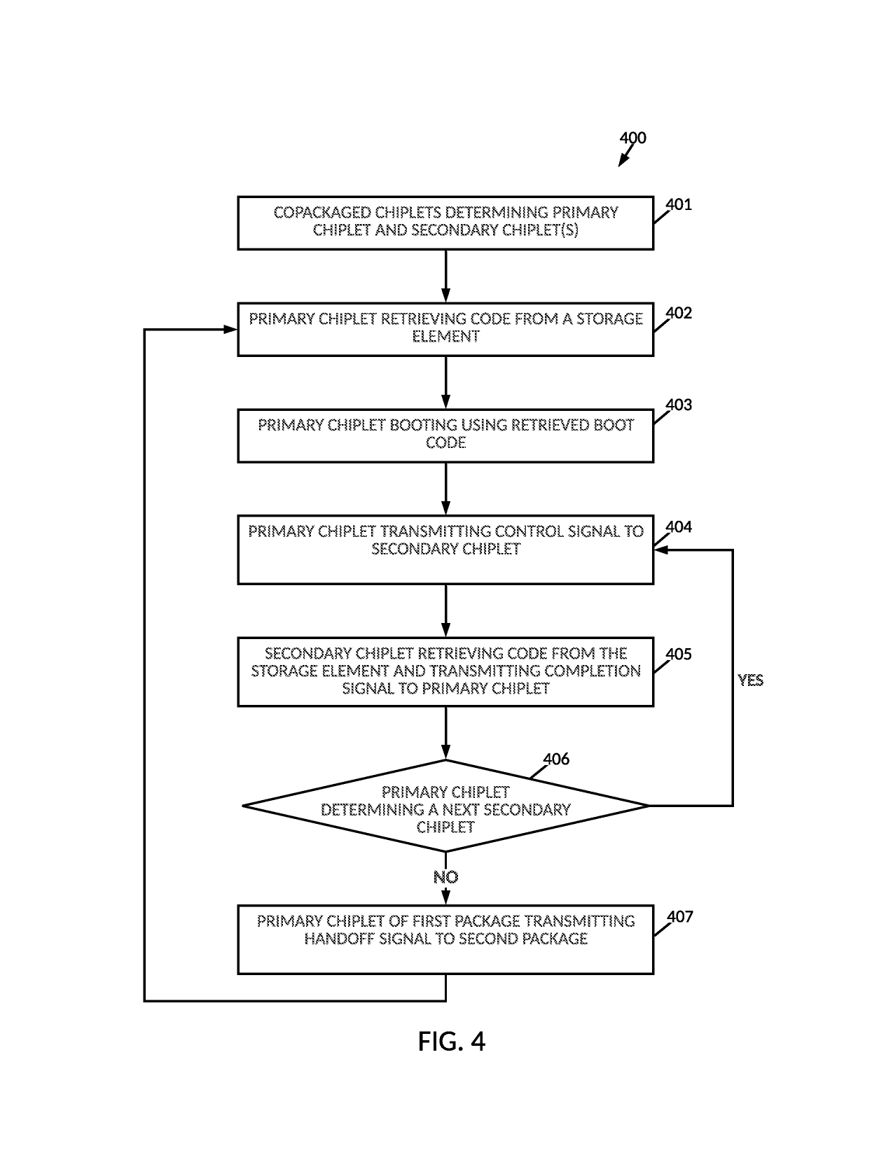

FIG. 2 illustrates an example method 200 of operation of a device such as device 101. While explained in terms of device 101, method 200 may illustrate the operation of any example described herein, such as, for example, example device 300 of FIG. 3. Additionally, example device 101 may operate as described with respect to any method described herein, such as for example, example method 400 of FIG. 4. For example, method 200 may be an example of aspects of a boot operation of a device 101, such as during a power-on event.

In some implementations, example method 200 may include operation 201, which may include a first chiplet retrieving first code from a storage element via an external bus. For example, operation 201 may include a first chiplet 103 operating external bus 108 as a main device to retrieve code from storage element 105. For example, operation 201 may be performed by chiplet logic that is operable prior to the chiplet having entered a normal operational state, such as boot controller 111. In some implementations, the code may comprise program code, such as executable code to be executed as an aspect of a device booting operation. For instance, operation 201 may comprise boot controller 111 retrieving code stored at a predetermined set addressed units of storage and loading this code into predetermined memory addresses accessible by chiplet 103. As another example, operation 201 may comprise boot controller 111 receiving code such as a cryptographic signature and/or the like, for instance, as an aspect of a secure/validated boot operation. In some implementations, such as those including an external bus 108 implementing a main-subordinate architecture (e.g., SPI, I2C, I3C, etc…), operation 201 may include boot controller 111 operating external bus 108 as a main device. In some implementations, other chiplets (e.g., chiplet 104) may disconnect themselves from external bus 108, such as by maintaining a tri-state terminal 109 in a high-impedance state.

In some implementations, example method 200 may include operation 202, which may include a first chiplet communicating a control signal to a second chiplet via an internal bus. For example, operation 202 may comprise chiplet 103 communicating a control signal to chiplet 104 via internal bus 106. In some cases, operation 202 may comprise boot controller 111 communicating the control signal to boot controller 112. In various implementations, the control signal may signal chiplet 104 to begin its boot code retrieval operations. In some implementations, the control signal may identify chiplet 104, such as for example, in the case of a plurality of secondary chiplets (see, e.g., FIG. 3). For instance, the control signal may include an identifier signal, or the control signal may be transmitted via a channel dedicated to chiplet 104 (e.g., a dedicated wire or other channel of bus 106). In some implementations, operation 202 may further include chiplet 103 disconnecting itself from external bus 108. For example, operation 202 may include boot controller 111 placing its terminal 107 to external bus 108 into a high-impedance state

In some implementations, example method 200 may include operation 203, which may include a second chiplet receiving the control signal from the first chiplet via the internal bus. In some cases, operation 203 may comprise second chiplet 104 executing and receiving the control signal via pre-boot logic, such as boot controller 112 to receive the control signal via internal bus 106. As an example, operation 203 may comprise boot controller 112 monitoring signals broadcast on internal bus 106 for a signal identifying chiplet 104. As another example, operation 203 may comprise boot controller 112 receiving a signal addressed to chiplet 104.

In some implementations, example method 200 may further include operation 204, which may include the second chiplet retrieving second code from the storage element via the external bus, responsive to the control signal. For example, operation 204 may comprise second chiplet 104 operating external bus 108 as a main device to retrieve boot code from storage element 105. For instance, such as in an implementation where external bus 108 comprises a single-main architecture, operation 204 may comprise pre-boot logic of second chiplet 104, such as boot controller 112, transitioning its external bus terminal 109 to a low-impedance state and connecting to external bus 108 as a main device. In some cases, the code for chiplet 104 retrieved from storage element 105 may be a copy of the same code as retrieved for chiplet 103. For instance, chiplet 103 and chiplet 104 may share executable boot code, security signatures, or other code. In some implementations, the code retrieved by boot controller 112 may be different, at least in part, from boot controller 111. For instance, boot controller 111 and 112 may retrieve and execute the same executable boot code, but might retrieve and validate different electronic signatures.

FIG. 3 illustrates an example system 300 in accordance with an implementation. As illustrated, system 300 may comprise a plurality of packages 301, 306, which comprise pluralities of chiplets 302-305, 307-310, respectively. In some implementations, one or more of packages 301, 306 may be implemented as described with respect to package 102 of FIGS. 1.

In some implementations, example system 300 may comprise a first package 301 and a second package 306. In various implementations, one of the plurality of packages 301, 306 may comprise a primary package and the remaining package(s) 301, 306 may comprise a secondary package(s). For ease of explanation, package 301 will be described as a primary package 301 and package 306 will be described as a secondary package 306. In some implementations, any of packages 301, 306 may be capable of operating as a primary package and as a secondary package. In some implementations, system 300 may include logic to determine the primary package 301. For example, chiplets 302-305, 307-310 may identify a particular package as a primary package 301 based on a common criteria. Accordingly, chiplets 302-305, 307-310 may identify a particular primary package 301 without communicating the identity. As an example, packages 301, 306 may comprise identifiers accessible to chiplets 302-305, 307-310 and chiplets 302-305, 307-310 may identify primary package 301 based on a common operation on the package identifiers. For instance, chiplets 302-305, 307-310 may identify the packaging having the minimum identifier as primary package 301 and the remaining packages 306 as secondary. In further implementations, packages 301, 306 may have their role established via manufacture and/or system configuration (e.g., via a value stored in a field-replaceable unit (FRU) or the like).

In some implementations, package 301 may comprise a plurality of chiplets 302-305. In various implementations, chiplets 302-305 may be implemented as described with respect to chiplets 103 and 104. Of course, package 301 may comprise any number of chiplets and its chiplets may have similar or different architectures. In various implementations, a particular chiplet may comprise a primary chiplet that orchestrates boot code retrieval operations of the remaining secondary chiplets.

In some implementations, some or all of chiplets 302-305 may be capable of operating as a primary chiplet. In some cases, the chiplets 302-305 may determine the primary chiplet according to a common operation. For example, each chiplet 302-305 may have an identifier and chiplets 302-305 may determine the primary chiplet according to an identifier criteria, such as the chiplet having a minimum identifier. For instance, chiplets 302-305 have an ordinal identity (e.g., 00, 01, 02, 03 …), which may be a configurable system parameter or may be based on other factors, such as, for example, its location within package 301. In some implementations, a chiplet may operate as a primary chiplet if its identity meets a selection condition. For example, a chiplet might operate as a primary chiplet if its identity is 00 and may operate as a secondary chiplet otherwise. In some implementations, each chiplet may determine its identity as operation responsive to a power-on event, such as during an aspect of booting prior to retrieving boot code. In some cases, chiplets 302-305 may perform this operation at each power-on event. In other cases, chiplets 302-305 may retain their primary/secondary identity across power cycles. For instance, chiplets 302-305 may store their primary/secondary identity in a persistent storage medium (e.g., flash memory, ROM, and/or the like). For ease of explanation, chiplet 302 will be described as a primary chiplet and chiplets 303-305 will be described as secondary chiplets in the following.

In some implementations, package 301 may comprise an external bus 319 and an internal bus 317. For example, external bus 319 may be a bus as described with respect to bus 108 of FIG. 1. For instance, external bus 319 may comprise a main-sub bus, such as an I2C, I3C, SPI bus, main-sub-architecture GPIO bus, and/or the like. Similarly, internal bus 317 may be a bus as described with respect to bus 106 of FIG. 1. For instance, internal bus 317 may comprise a bus implementing a chiplet-to-chiplet protocol such as Bunch of Wires (BoW), a general protocol such as I2C, I3C, SPI, SSI, and/or the like, and/or a protocol-less digital signal interconnect, such as a general-purpose input/output (GPIO) bus.

In some implementations, chiplets 302-305 may retrieve boot code from a storage element 311 via external bus 319 as orchestrated by primary chiplet 302. For example, primary chiplet 302 may orchestrate a boot process, such as described with respect to FIGS. 2 and/or 4. In some implementations, primary chiplet 302 may communicate control signals to secondary chiplets 303-305 via internal bus 317. For example, primary chiplet 302 may be an initial main device on external bus 313. In some cases, secondary chiplets 303-305 may be initially disconnected from external bus 313 (e.g., via a tri-state bus terminal). In further cases, secondary chiplets 303-305 may connect to the external bus 319 as a sub device or other role provided by an external bus 319 protocol (e.g., a back-up main device, etc…).

In some implementations, during a boot operation, primary chiplet 302 may retrieve its boot code and then transmit a signal on internal bus 317 identifying a next secondary chiplet 303 that retrieve its boot code. In this example, primary chiplet 302 may disconnect from the external bus 319 and identified second chiplet 303 may connect to bus 319 as a main device. Here, after retrieving its boot code, secondary chiplet 303 may communicate a completion signal to primary chiplet 302. For example, secondary chiplet 303 may have a device ready signal which is asserted as a “ready” state when not actively booting and asserted as an “not ready” state while operating bus 319 and/or booting. In this example, a completion signal may comprise secondary chiplet 303 reasserting the “ready” state. Continuing the example, after receiving the completion signal, primary chiplet 302 may identify a next chiplet 304 via the internal bus 317. Primary chiplet may continue as described to allow each chiplet of the plurality 302-305 to retrieve their boot code.

In various implementations, chiplets 302-305 may share various resources. For example, chiplets 302-305 may share a terminal 313 to access external bus 319 and storage 311 as described above. In further implementations, chiplets 302-305 may share other resources, such as, for example, a memory subsystem 312 (e.g., DDR5 RAM and/or other memory-addressed medium). For example, chiplets 302-305 may store boot code that will be used during the boot process at a common set of memory addresses. Accordingly, less memory 312 may be used compared to each chiplet 302-305 having separate boot memory address ranges. In some implementations, secondary chiplets 303-305 may transmit a completion signal to primary chiplet 302 when they reach a particular operational state. For instance, secondary chiplets 303-305 may transmit a completion signal responsive to completing the boot process, reaching a stage in boot process where shared resources (e.g., external bus 319, memory 312, etc...) are no longer in use, completing a security check (e.g., cryptographic signature comparison, etc...) or other synchronization point. As an example, chiplets 303-305 may transmit their completion signal after conducting a security check following completion of a boot stage using shared boot memory 312. Accordingly, a failure of the security check may prevent a chiplet 303-305 from sending its completion signals, which may halt the system boot process in the event of an insecure device 301.

As described above, some implementations may include multiple packages 301, 306. For example, system 300 may comprise any number of interconnects to couple to a chiplet package 301, 306 (e.g., “sockets”). For instance, system 300 may comprise a two, four, eight, or other numbered socket system. In some implementations, a plurality of packages 301, 306 may coordinate boot operations. For example, the plurality of packages 301, 306 may comprise all such packages in a system or a subset of packages 301, 306, such as a subset of packages 301, 306 in a defined group of sockets.

In some implementations, system 300 may comprise an external bus 321 connecting packages 301, 306. In various implementations, external bus 321 may be the same bus as external bus 319 or may comprise a second external bus 321. Such a second external bus 321 may implement the same or a different protocol than first external bus 319 and/or internal bus 317. As an example, second internal bus 321 may comprise an interconnect bridging internal bus 317 of package 301 and an internal bus 320 of package 302. As another example, second external bus 321 may comprise a bus linking primary chiplet 302 to a primary chiplet 307 of package 306.

In some implementations, package 306 may comprise a primary chiplet 307 and secondary chiplets 308-310. For example, package 306 may be as described with any implementation of package 301. For instance, compared to package 301 and chiplets 302-305, package 306 may a different type of chiplet package (e.g., a 2.5D package compared to a multi-stack package, etc…), package 306 may have the same or different number of chiplets 307-310, chiplets 307-310 may have similar or different designs/architectures, etc…. In various implementations, packages 301, 306 may share boot resources, such as boot code storage 311 and/or boot memory 312. In some implementations, packages 301, 306 may coordinate their boot process. For example, packages 301, 306 may boot in at least a partially sequential manner under orchestration by a chiplet within a primary package 301, such as primary chiplet 302.

In some implementations, primary chiplet 307 (of package 306) may wait for a signal from primary chiplet 302 before beginning to orchestrate code retrieval for chiplets 307-310. For example, primary chiplet 302 may transmit a handoff signal to package 307 responsive to the final secondary chiplet 303-305 communicating its final completion signal. In some implementations, such as implementations with two co-packaged chiplets, the final secondary chiplet 303-305 may also be the first and/or only secondary chiplet.

Responsive to receiving the control signal via external bus 321, primary chiplet 307 may orchestrate code retrieval and/or other boot operations as described with respect to primary chiplet 302. For example, primary chiplet 307 may connect to external bus 319 via a shared external bus terminal 314 as a main device and retrieve boot code from storage 311. After booting to a threshold operational stage, chiplet 307 may iteratively signal secondary chiplets 308-310 to retrieve their boot code and conduct boot operations. For example, chiplet 307 may signal a next secondary chiplet after receiving a completion signal from a current secondary chiplet. In various implementations, primary chiplet 307 may communicate with secondary chiplets 308-310 via an internal bus 320 disposed in package 306. For example, internal bus 320 and communications thereon may be as described with respect to internal bus 317 of package 301. In some implementations including more than two packages 301, 306, primary chiplet 307 may transmit a control signal to a third package after its co-packaged chiplets have completed. In some other such implementations, primary chiplet 307 may transmit a completion signal to primary chiplet 302 and primary chiplet 302 may transmit a control signal to a third package.

FIG. 4 illustrates a method 400 of operation, such as of device 101 and/or 300. For example, method 400 may be an implementation of method 200 of FIG. 2 or any other operational method described herein. For example, method 400 may be an example of aspects of a boot operation of a device 100 of FIG. 1, or a device 300 of FIG. 3, such as during a power-on event.

In some implementations, method 400 may include operation 401, which may include co-packaged chiplets determining a primary chiplet. For example, operation 401 may comprise chiplets identifying a primary chiplet based, at least in part, on a location within a package, a topological location, identifier, and/or the like. In some implementations, the chiplet(s) not identified as a primary chiplet may be identified as secondary chiplet(s). For instance, operation 401 may be performed separately by each co-packaged chiplet, such as, for example, as described with respect to chiplets 104, 103 of FIG. 1 and/or chiplets 302-305; 307-310, or as otherwise described herein.

In some implementations, method 400 may include operation 402, which may include a primary chiplet retrieving code from a storage element. For example, a primary chiplet may connect to a storage element as a main device on an external bus, where the storage element is a sub device. As an example, primary chiplet may connect to the external bus via an external bus terminal that is shared with the other co-packaged chiplets. In various implementations, the code may include code used during a boot operation, such as executable boot code, security certificates, and/or the like. In some implementations, operation 402 may be performed as described with respect to external bus 108 of FIG. 1, operation 201 of FIG. 2, external bus 319 of FIG. 3, or otherwise described herein.

In some implementations, method 400 may comprise operation 403, which may include a primary chiplet booting using retrieved boot code. For example, method 400 may include operation 403 in implementations where code retrieved in operation 402 comprises boot code. For instance, operation 403 may comprise booting to a predetermined operational stage, such as a mid-boot stage after the primary chiplet completes its use of shared resources, after the primary chiplet completes a security validation, when the primary chiplet enters a normal operational state, and/or the like. In various implementations, operation 403 may be performed as described with respect to the operation of any primary chiplet as described herein.

In some implementations, method 400 may comprise operation 404, which may include a primary chiplet communicating a control signal to a secondary chiplet. For example, operation 404 may comprise the primary chiplet communicating the control signal to the secondary chiplet via an internal bus that is internal to the chiplets’ package. For instance, operation 404 may comprise the primary chiplet communicating a control signal comprises a particular secondary chiplet identifier. In some cases, operation 404 may comprise the primary chiplet disconnecting from the external bus. For instance, operation 404 may comprise the primary chiplet placing its package-internal terminal to the external bus in a high-impedance state (e.g., as described with respect to terminal 107 of FIG. 1). In various implementations, operation 404 may be further performed as described with respect to internal bus 106 of FIG. 1, operation 202 of FIG. 2, internal buses 317, 320 of FIG. 3, or otherwise described herein.

In some implementations, method 400 may include operation 405, which may include a secondary chiplet retrieving code from the storage element and communicating a completion signal to a primary chiplet. For instance, operation 405 may comprise the secondary chiplet retrieving the code responsive to receiving a control signal in operation 404. In some implementations, the secondary chiplet may connect to an external bus as a main device via a shared external bus terminal to retrieve the code. For example, the secondary chiplet may transition its package internal terminal to the external bus (e.g., terminal 109 of FIG. 1) into a conductive state and control the storage element sub device as a main device. In some implementations, operation 405 may further comprise a secondary device communicating a completion signal after retrieving code. For example, operation 405 may comprise a secondary device booting to a threshold operational state in various implementations, operation 405 may be further performed as described with respect to chiplet 104 of FIG. 1, operation 204 of FIG. 2, chiplets 303-305, 308-310 of FIG. 3, or as otherwise described herein.

In some implementations, method 400 may include operation 406, which may include a primary chiplet determining if there are remaining co-packaged secondary chiplets to retrieve their code. For example, method 400 may comprise operation 406 in an implementation of a packaged device comprising three or more chiplets, such as, for example, packages 301, 306 of FIG. 3. In some implementations, the primary chiplet may perform operation 406 responsive to receiving a completion signal in operation 405. If there are remaining co-package chiplets to retrieve code, operation 406 may comprise the primary chiplet returning to operation 404 to transmit a next control signal to a next chiplet. For example, operation 406 may be performed as described with respect to primary chiplet 302 and secondary chiplets 303-305 of FIG. 3.

In some implementations, if there are no remaining secondary chiplets, then method 400 may complete and the chiplet package may enter a normal operational state. In other implementations, method 400 may comprise operation 406, which may include a primary chiplet of a first package communicating a handoff signal to a second package. For example, operation 406 may be performed as described with respect to first primary chiplet 302 communicating a handoff signal to second primary chiplet 307 via bus 321.

In some implementations, operation 407 may further comprise a second primary chiplet performing one or more operations of method 400. For example, the second primary chiplet may proceed to operation 402 to retrieve code from the storage element. For instance, this may occur if the second primary chiplet and its co-packaged chiplets had conducted operation 401 prior to receiving the handoff signal. For example, second primary chiplet may identify that it is an element of a secondary package and wait for the handoff signal. In further implementations, the handoff signal may trigger the second plurality of chiplets to perform operation 401. Accordingly, in various implementations, operation 407 may be performed as described with respect to second package 306 and chiplets 307-310 of FIG. 3.

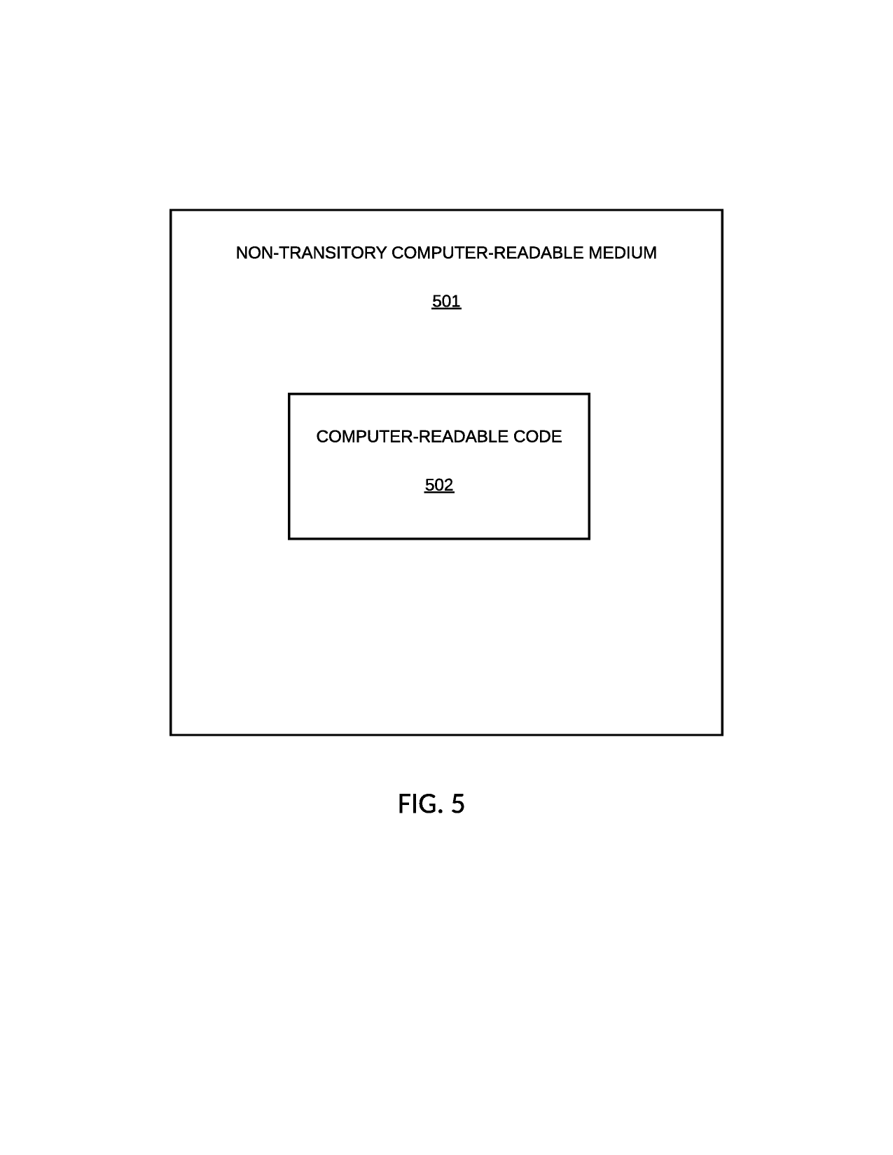

Attention is now drawn to FIG. 5, which illustrates an example of a non-transitory computer-readable medium 501 comprising computer-readable code 502. Concepts described herein may be embodied in computer-readable code 502 for fabrication of an apparatus that embodies the described concepts. For example, the computer-readable code 502 can be used at one or more stages of a semiconductor design and fabrication process, including an electronic design automation (EDA) stage, to fabricate an integrated circuit comprising the apparatus embodying the concepts. The above computer-readable code 502 may additionally or alternatively enable the definition, modeling, simulation, verification and/or testing of an apparatus embodying the concepts described herein.

For example, the computer-readable code 502 for fabrication of an apparatus embodying the concepts described herein can be embodied in code 502 defining a hardware description language (HDL) representation of the concepts. For example, the code 502 may define a register-transfer-level (RTL) abstraction of one or more logic circuits for defining an apparatus embodying the concepts. The code 502 may define an HDL representation of the one or more logic circuits embodying the apparatus in Verilog, SystemVerilog, Chisel, or VHDL (Very High Speed Integrated Circuit Hardware Description Language) as well as intermediate representations such as FIRRTL. Computer-readable code 502 may provide definitions embodying the concept using system-level modeling languages such as SystemC and SystemVerilog or other behavioral representations of the concepts that can be interpreted by a computer to enable simulation, functional and/or formal verification, and testing of the concepts.

Additionally or alternatively, the computer-readable code 502 may define a low level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code 502 a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code 502 may comprise a mix of code 502 representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code 502 defining instructions which are to be executed by the defined apparatus once fabricated.

Such computer-readable code 502 can be disposed in any known transitory computer-readable medium (such as wired or wireless transmission of code over a network) or non-transitory computer-readable medium 501 such as semiconductor, magnetic disk, or optical disc. An integrated circuit fabricated using the computer-readable code 502 may comprise components such as one or more of a central processing unit, graphics processing unit, neural processing unit, digital signal processor or other components that individually or collectively embody the concept.

Unless otherwise indicated, in the context of the present disclosure, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Furthermore, the terms “first,” “second” “third,” and the like are used to distinguish different aspects, such as different components, as one example, rather than supplying a numerical limit or suggesting a particular order, unless expressly indicated otherwise. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, to be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

Some configurations of the present techniques are described by the following numbered clauses:

Clause 1: A device, comprising:

What is claimed is:

1. A device, comprising:
a storage element coupled to an external bus;
a primary chiplet coupled to the external bus via an external bus terminal to retrieve first code from the storage element and coupled to an internal bus to communicate a control signal; and
a secondary chiplet coupled to the internal bus to receive the control signal from the primary chiplet and coupled to the external bus via the external bus terminal to retrieve second code from the storage element responsive to the control signal.

2. The device of claim 1, wherein the primary chiplet is to operate as a main device on the external bus to retrieve first code and the secondary chiplet is to operate as the main device on the external bus to retrieve second code responsive to the control signal.

3. The device of claim 1, wherein, after retrieving the second code, the secondary chiplet is to communicate a completion signal to the primary chiplet via the internal bus.

4. The device of claim 1, wherein the secondary chiplet is one of a plurality of secondary chiplets, each respective secondary chiplet coupled to the internal bus to receive a respective control signal from the primary chiplet and coupled the external bus to retrieve respective code from the storage element responsive to the respective control signal.

5. The device of claim 1, further comprising a first package comprising the primary chiplet and the secondary chiplet, the first package comprising an external bus interface coupled to the external bus, the primary chiplet, and the secondary chiplet.

6. The device of claim 5, further comprising:
a second package comprising a second plurality of chiplets coupled to the external bus, the second plurality of chiplets comprising a second primary chiplet and a second secondary chiplet, wherein:
the second primary chiplet is to retrieve third code from the storage element responsive to a handoff signal received from the primary chiplet of the first package;
the second primary chiplet is to communicate a second control signal to the second secondary chiplet responsive to retrieving the third code; and
the second secondary chiplet is to retrieve fourth code from the storage element responsive to the second control signal.

7. The device of claim 1, wherein:
the first code comprises first boot code and the primary chiplet is to validate the first boot code, to boot using the first boot code, and to communicate the control signal responsive to booting, and
the second code comprises second boot code and the second chiplet is to validate the second boot code, to boot using the second boot code, and to communicate the control signal responsive to booting.

8. The device of claim 7, wherein the first boot code and the second boot code comprise copies of a common boot code.

9. The device of claim 1, wherein the primary chiplet and the second chiplet are to identify the primary chiplet based, at least in part, on a location of the primary chiplet within a package comprising the primary chiplet and the secondary chiplet.

10. A method, comprising:
a first primary chiplet retrieving code from a storage element via an external bus terminal connected to an external bus;
the first primary chiplet communicating a control signal to a secondary chiplet via an internal bus, the secondary chiplet being co-packaged with the first primary chiplet;
the secondary chiplet receiving the control signal from the first primary chiplet; and
responsive to the control signal, the secondary chiplet retrieving code from the storage element via the external bus terminal.

11. The method of claim 10, further comprising:
the first primary chiplet operating as a main device on the external bus to retrieve code; and
the secondary chiplet operating as the main device on the external bus to retrieve code.

12. The method of claim 10, wherein the first primary chiplet and the secondary chiplet at least a portion of code retrieved by the first primary chiplet and the secondary chiplet comprises common boot code.

13. The method of claim 10, further comprising:
the secondary chiplet communicating a completion signal to the first primary chiplet after retrieving code;
the first primary chiplet communicating a second control signal to a next secondary chiplet via the internal bus, the next secondary chiplet being co-packaged with the first primary chiplet; and
responsive to the control signal, the next secondary chiplet retrieving code from the storage element via the external bus terminal.

14. The method of claim 13, further comprising:
the secondary chiplet retrieving boot code; and
the secondary chiplet communicating the completion signal responsive to validating the boot code.

15. The method of claim 14, further comprising the secondary chiplet communicating the completion signal responsive to booting to a threshold operational state.

16. The method of claim 10, further comprising:
responsive to receiving a completion signal, the first primary chiplet communicating a handoff signal to a second primary chiplet, the second primary chiplet being separately packaged from the first primary chiplet.

17. The method of claim 16, further comprising:
the second primary chiplet retrieving code from a storage element via a second external bus terminal connected to the external bus;
the second primary chiplet communicating a second control signal to a second secondary chiplet via a second internal bus, the second secondary chiplet being co-packaged with the second primary chiplet;
the second secondary chiplet receiving the second control signal from the second primary chiplet; and
responsive to the control signal, the second secondary chiplet retrieving code from the storage element via the second external bus terminal.

18. The method of claim 16, further comprising:
the second primary chiplet communicating a package completion signal to the first primary chiplet responsive to receiving a second completion signal.

19. The method of claim 10, further comprising:
the first primary chiplet and secondary chiplet identifying the first primary chiplet based, at least in part, on a package location of the first primary chiplet.

20. A non-transitory computer-readable medium storing computer-readable code for fabrication of an apparatus comprising:
a package comprising a plurality of chiplets, an internal bus, and an external bus terminal;
a primary chiplet of the plurality of chiplet coupled to the external bus terminal, the primary chiplet to operate an external bus coupled to the external bus terminal as a main device to retrieve first code from a storage element, and the primary chiplet coupled to the internal bus to communicate a control signal; and
a secondary chiplet of the plurality of chiplets coupled to the internal bus and the external bus terminal, the secondary chiplet to receive the control signal from the primary chiplet, the secondary chiplet to operate the external bus as the main device to retrieve second code from the storage element responsive to the control signal.
